(19) United States
(12) Patent Application Publication
(10) Pub. No.: US 2023/0244825 A1
(43) Pub. Date: Aug. 3, 2023

(54) TECHNOLOGIES FOR DIGITALLY RENDERING THREE DIMENSIONAL DESIGNS FOR FOLDABLE PRODUCTS

(71) Applicant: CIMPRESS SCHWEIZ GMBH, Winterthur (CH)

(72) Inventors: Deepak Bansal, Rajasthan (IN); Devjit Neogi, Jharkhand (IN)

(21) Appl. No.: 17/587,738

(22) Filed: Jan. 28, 2022

(51) Int. Cl. G06F 30/12

(52) U.S. Cl. CPC G06F 30/12; G06F 2111/16

(57) ABSTRACT

Systems and methods for rendering foldable products are described. According to certain aspects, an electronic device enables a user to select a digital content item and a section of a foldable product on which to render the digital content item. Based on certain parameters associated with the section, the electronic device may calculate a position within a cell for the digital content item, where the cell may be part of a bounding box associated with the section. The electronic device may render, within a user interface, the a digital design of the foldable product with the digital content item rendered on the section and positioned at the position within the cell.

### FIELD

The present disclosure is directed to improvements related to rendering digital designs. More particularly, the present disclosure is directed to platforms and technologies for assessing positioning of digital content items within digital designs of foldable products.

### BACKGROUND

Various printing and design services (e.g., via websites) that enable users to design products are well known and widely used by many consumers, professionals, and businesses. Personalized products may include both printed paper products and customized promotional products including, for instance, various articles of clothing such as t-shirts. Other products include folded cards, packaging boxes, display mailers, and the like. The services offer a way for users to upload completed or partially-completed pages or images, as well as create and edit designs for the products.

However, in the case of foldable products, these existing services either enable users to design a single facet of a given product at a time, or present the product in an unfolded form in its entirety to design. Both of these options only offer complex design techniques, and require more time and skill to create a desired product design. Accordingly, there is an opportunity for systems and methods to enable effective and efficient design of digital content items in association with digital designs of foldable products.

### SUMMARY

In an embodiment, a computer-implemented method of determining content placement on a digital design of a foldable product having a plurality of sections is provided. The computer-implemented method may include: identifying, by one or more processors, (i) a digital content item having a content width and a content height, and (ii) a section of the plurality of sections of the foldable product on which to render the digital content item; accessing, by the one more processors, a set of parameters associated with the section on which to render the digital content item; determining, by the one or more processors from the set of parameters, a bounding box associated with the section, the bounding box having a bounding box width and a bounding box height, the bounding box having a cell within which to position the digital content item; calculating, by the one or more processors, a position within the cell for the digital content item based on at least the content width, the content height, the bounding box width, and the bounding box height; and causing a user interface of an electronic device to render the digital design of the foldable product with the digital content item rendered on the section and positioned at the position within the cell.

In another embodiment, a system for determining content placement on a digital design of a foldable product having a plurality of sections is provided. The system may include a user interface, a memory, and one or more processors interfacing with the user interface and the memory. The one or more processors may be configured to: identify (i) a digital content item having a content width and a content height, and (ii) a section of the plurality of sections of the foldable product on which to render the digital content item, access a set of parameters associated with the section on which to render the digital content item, determine, from the set of parameters, a bounding box associated with the section, the bounding box having a bounding box width and a bounding box height, the bounding box having a cell within which to position the digital content item, calculate a position within the cell for the digital content item based on at least the content width, the content height, the bounding box width, and the bounding box height, and cause the user interface to render the digital design of the foldable product with the digital content item rendered on the section and positioned at the position within the cell.

Further, in an embodiment, a computer-implemented method of rendering a digital design of a foldable product having a plurality of sections may be provided. The computer-implemented method may include: receiving, by one or more processors via a user interface, a set of selections for (i) a digital content item having a content width and a content height, (ii) a section of the plurality of sections of the foldable product on which to render the digital content item, and (iii) a layout associated with the section at which to position the digital content item; determining, by the one or more processors, a bounding box associated with the section, the bounding box having a bounding box width and a bounding box height, and, based on the layout, a cell of the bounding box within which to position the digital content item; calculating, by the one or more processors, a position within the cell for the digital content item based on at least the content width, the content height, the bounding box width, and the bounding box height; and displaying, in the user interface, the digital design of the foldable product with the digital content item rendered on the section and positioned at the position within the cell.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2 illustrates an example design of a foldable product, in accordance with some embodiments.

FIG. 3 illustrates an overview of parameters and calculations associated with positioning a digital content item within a digital design, in accordance with some embodiments.

FIGS. 4A-4E depict example renderings of foldable products with digital content items positioned thereon, in accordance with some embodiments.

FIG. 5 illustrates an example flow diagram of determining content placement on a digital design of a foldable product, in accordance with some embodiments.

FIG. 6 is a hardware diagram of an example server and an example electronic device configured to facilitate the described techniques, in accordance with some embodiments.

### DETAILED DESCRIPTION

The present embodiments may relate to, inter alia, platforms and technologies for rendering digital designs of foldable products. Generally, a foldable product may include a plurality of sections that may be maneuvered or folded to form a folded (or unfolded) product. According to certain aspects, systems and methods digitally render the foldable products, where one or more of the sections may include a digital content item(s) positioned thereon.

The systems and methods may enable a user to select a digital content item to position on a given section, and according to a given layout, of a foldable product. Based on a set of parameters associated with the section, the systems and methods may calculate a position within the section at which to position the digital content item. Additionally, the systems and methods may render a digital design of the foldable product with the digital content item rendered on the section and positioned at the calculated position. The systems and methods may further enable for the addition of textual content to the digital design.

The systems and methods offer numerous benefits. In particular, the systems and methods enable users to efficiently and effectively design different facets of foldable products, and specifically to select where and how to place digital content items on digital designs of foldable products. Additionally, the systems and methods accurately render the foldable products with the digital content items positioned thereon. This enables users to accurately gauge the look and appearance of foldable products, as well as quickly design and modify sections of foldable products, such as in contemplation of placing an order for a physical version of the foldable product. Moreover, entities who support online design studios may offer improved customer experience and may experience increased sales. It should be appreciated that additional benefits are envisioned.

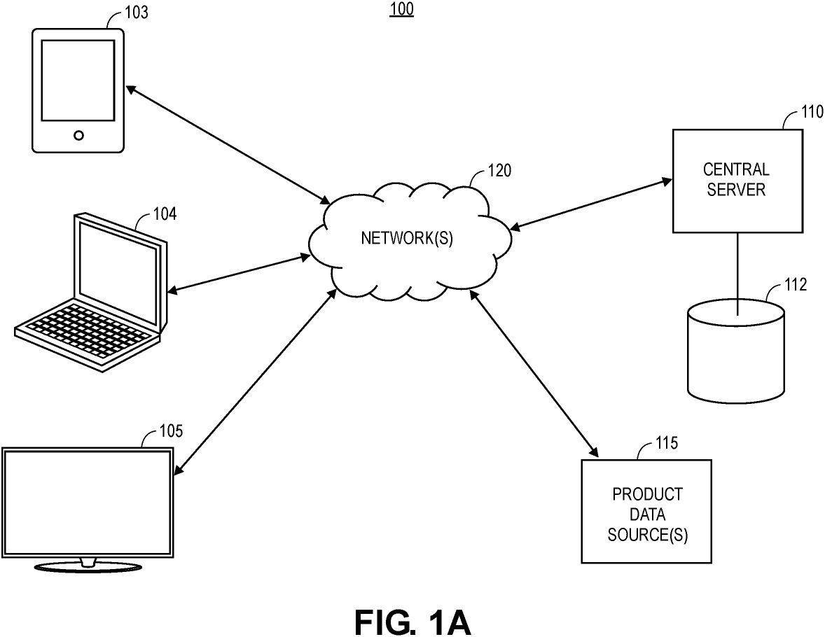

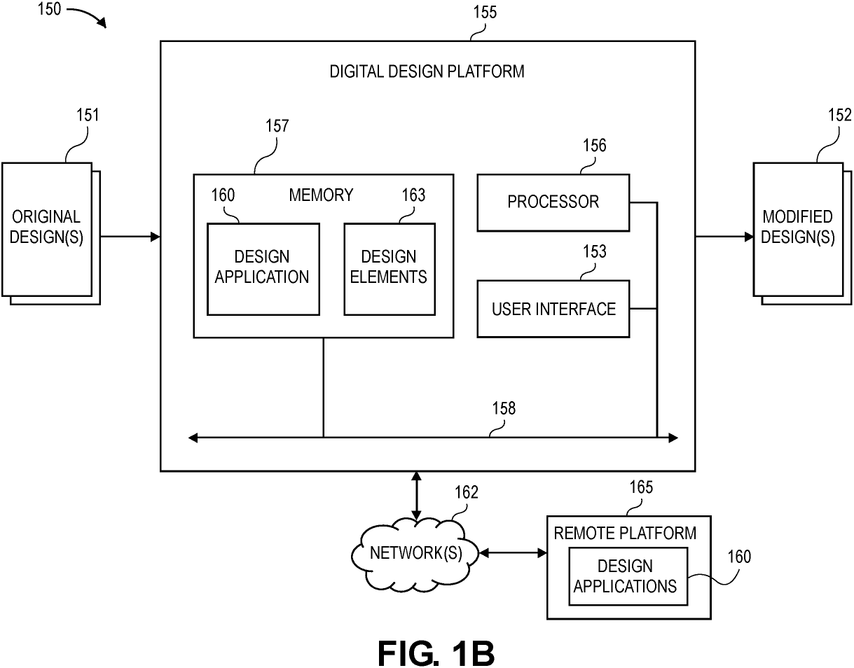

FIG. 1A illustrates an overview of a system 100 of components configured to facilitate the systems and methods. It should be appreciated that the system 100 is merely an example and that alternative or additional components are envisioned.

As illustrated in FIG. 1A, the system 100 may include a set of electronic devices 103, 104, 105 which may be used or operated by a set of users, such as any individual or person who may be interested in creating, sharing, and/or saving a digital design(s), such as a digital design of a foldable product. Each of the electronic devices 103, 104, 105 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. Each of the electronic devices 103, 104, 105 may execute or interface with an design application or platform that enables the creating, rendering, editing, sharing, and/or saving of the digital design(s).

The electronic devices 103, 104 105 may communicate with a central server 110 via one or more networks 120. The central server 110 may be associated with the entity that owns, operates, and/or manages the design application or platform. In particular, the central server 110 may include or support a web server configured to host a website that enables users to operate the design application or platform. Further, the central server 110 may support a software application executable by the set of electronic devices 103, 104, 105 (i.e., the set of electronic devices 103, 104, 105 may interface with the central server 110 in executing the software application). In embodiments, the network(s) 120 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others).

Although depicted as a single central server 110 in FIG. 1A, it should be appreciated that the server 110 may be in the form of a distributed cluster of computers, servers, machines, or the like. In this implementation, the entity may utilize the distributed server(s) 110 as part of an on-demand cloud computing platform. Accordingly, when the electronic devices 103, 104, 105 interface with the server 110, the electronic devices 103, 104, 105 may actually interface with one or more of a number of distributed computers, servers, machines, or the like, to facilitate the described functionalities.

The central server 110 may be configured to interface with or support a memory or storage 112 capable of storing various data, such as in one or more databases or other forms of storage. According to embodiments, the storage 112 may store data or information associated with digital designs, formats, templates, and/or design elements for the digital designs and templates, as well as data associated with various products for which digital designs may be created. According to embodiments, the products may be foldable products having one or more seams or edges that are designed to be folded. For example, the storage 112 may store a template for a foldable box, including design elements for the template. The system 100 may further include a set of product data sources 115, each of which may alternatively or additionally store the data associated with the various products for which digital designs may be created. Accordingly, the set of electronic devices 103, 104, 105 may interface with the central server 110 and/or the product data source(s) 115 to retrieve information related to digital designs of products.

Although three (3) electronic devices 103, 104, 105 and one (1) central server 110 are depicted in FIG. 1A, it should be appreciated that greater or fewer amounts are envisioned. For example, there may be multiple central servers, each one associated with a different entity.

According to embodiments, users of the electronic devices 103, 104, 105 may select a product on which to create and/or modify a digital design(s) using the electronic devices 103, 104, 105, such as in contemplation of placing an order for a physical version of the product with the digital design applied thereon. The digital design(s) may include at least one digital image or video in various file formats (e.g., JPEG, TIFF, GIF, PNG, Raw, MP4, MOV, etc.), where the digital image(s) or video(s) may depict visual content (i.e., the design itself) that may be composed of one or more design elements. The users may use the respective electronic devices 103, 104, 105 to modify certain of the design elements across one or more formats, add textual content to the digital design(s), and select one or more sections and locations within the sections of the product on which to apply the digital design(s). FIG. 1B depicts more specific components associated with the systems and methods.

FIG. 1B depicts an example environment 150 in which an original design(s) 151 is processed into a modified design(s) 152 via a digital design platform 155, according to embodiments. The digital design platform 155 may be implemented on any computing device, including one or more of the electronic devices 103, 104, 105 or the server 110 as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156. In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The digital design platform 155 may further include a user interface 153 configured to present content (e.g., digital designs, renderings or foldable products, and components/elements thereof). Additionally, a user may make selections to the content via the user interface 153, such as to modify digital designs (or design elements thereof) presented thereon, choose various selections, and/or the like. The user interface 153 may be embodied as part of a touchscreen configured to sense touch interactions and gestures by the user. Although not shown, other system components communicatively coupled to the system bus 158 may include input devices such as a cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a design application 160) data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The digital analysis platform 155 may operate in a networked environment and communicate with one or more remote platforms, such as a remote platform 165, via a network(s) 162, such as a local area network (LAN), a wide area network (WAN), or other suitable network. The platform 165 may be implemented on any computing device, including one or more of the electronic devices 103, 104, 105 or the server 110 as discussed with respect to FIG. 1A, and may include many or all of the elements described above with respect to the platform 155. In some embodiments, the design application 160 as will be further described herein may be stored and executed by the remote platform 165 instead of by or in addition to the platform 155.

Generally, each of the original design(s) 151 and the modified design(s) 152 may be embodied as any type of electronic document, file, template, etc., that may include various graphical/visual and/or textual content, and may be stored in memory as program data in a hard disk drive, magnetic disk and/or optical disk drive in the digital design platform 155 and/or the remote platform 165. The digital design platform 155 may support one or more techniques, algorithms, or the like for modifying the original design(s) 151 to generate the modified design(s) 152.

According to embodiments, the original design 151 may represent a foldable product having a plurality of sections, where the plurality of sections are divided by “fold lines” such as seams or edges. For a physical version of the foldable product, the plurality of sections may correspond to a plurality of surfaces that are maneuverable according to the fold lines such that a folded or unfolded product may be formed. The design application 160 may enable a user to select one or more digital content items as well as textual content to add to the original design 151. According to embodiments, a digital content item may comprise any combination of visual content and alphanumeric text, and may be, for example, a logo, an image, a design, or the like. The digital content item may have a content width and a content height, and may be accessed from a set of design elements 163 stored by the memory 157. Further, the design application 160 may enable the user to select a section of the plurality of sections as well as a cell or layout of the section at which to position a given digital content item.

Each of the sections of the original design 151 may be defined by a set of parameters such as a set of scalable vector graphic (SVG) paths. The design application 160 may determine, from the set of parameters, a bounding box associated with the section, where the bounding box may have a bounding box width and a bounding box height. Additionally, the bounding box may have a plurality of cells, one of which may be specified by the user as the cell in which to position the digital content item.

Based on the content height, the content width, the bounding box height, and the bounding box width, the design application 160 may calculate a position within the specified cell for the digital content item. The design application 160 may generate a digital design of the foldable product with the digital content item rendered on the selected section and position at the position within the cell. The generated digital design may be embodied as the modified design 152. Additionally, the user interface 153 (or another user interface, such as a user interface of one of the electronic devices 103, 104, 105) may display or present the digital design of the foldable product (i.e., the modified design 152). According to embodiments, digital design platform 155 may support placing an order for a physical version of the digital design. Further, the digital design platform 155 may store the modified design(s) 152 in the memory 157 or other storage, and/or may transmit the modified design(s) 152 to other components or entities for display, sharing, further transmission, and/or the like. According to embodiments, the original design(s) 151 and the modified design(s) 152 may include at least one digital image or video in various file formats (e.g., JPEG, TIFF, GIF, PNG, Raw, MP4, MOV, etc.).

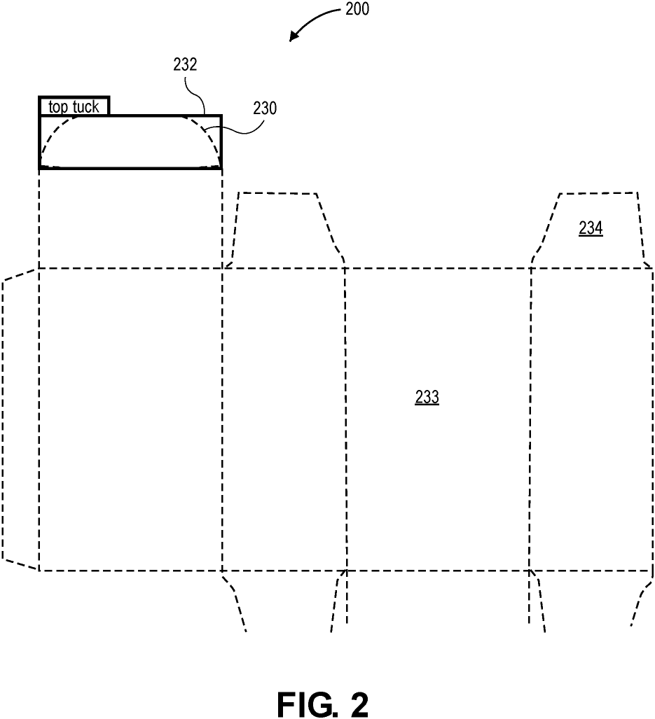

FIG. 2 illustrates an example design 200 of a foldable product. According to embodiments, the foldable product may include a plurality of sections that may each correspond to a surface or side of the foldable product, and where the dotted lines may each correspond to a folding line (e.g., an edge or seam) of the foldable product. Each section may be editable or designable. Generally, when none of the folds of the foldable product are completed or maneuvered, the foldable product may be in its unfolded state; and when all of the folds of the foldable product are completed or maneuvered, the foldable product may be in its folded state.

According to embodiments, each section may be specified by a set of scalable vector graphics (SVG) paths, or another format. It should be understood that a given section may be any enclosed shape with any number of straight or curved edges. For example, a given section may be a square, rectangle, circle, trapezoid, oval, or other type of regular or irregular shape. As illustrated in FIG. 2, a section 233 is a rectangle, a section 234 is a type of trapezoid shape, and a section 230 is a type of trapezoid shape with two (2) curved edges.

According to embodiments, a computing device may calculate or determine a bounding box for a given section. As illustrated in FIG. 2, the section 230 has a corresponding bounding box 232. According to embodiments, a given bounding box for a given section may be a “close fit” bounding box having a set of edges and that may be in the shape of a rectangle or square. The computing device may calculate or determine the parameters of the bounding box such that the area of the bounding box is as small as possible while the edges of the bounding box either overlap with or enclose all of the edges of the section. As illustrated in FIG. 2, the edges of the bounding box 232 either overlap with or enclose all of the edges of the section 230. It should be appreciated that the computing device may similarly calculate or determine the bounding boxes for the remaining sections of the design 200.

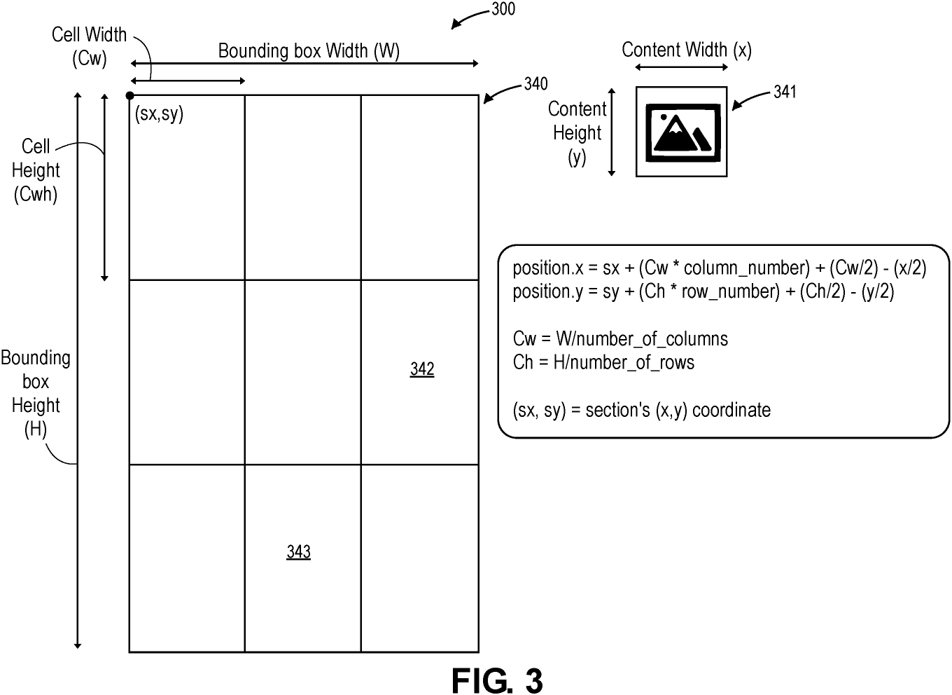

FIG. 3 illustrates an overview 300 of parameters and calculations associated with a bounding box associated with a section and a digital content item that is to be positioned within the section. As illustrated in FIG. 3, a bounding box 340 (and/or the associated section) may be divided into a set of cells, areas, or portions (generally, “cells”). For example, a given section or bounding box may have nine (9) cells: top left, top center, top right, left, center, right, bottom left, bottom center, and bottom right. It should be appreciated that a bounding box may have a different amount of cells of differing sizes and layouts.

According to embodiments, the bounding box 340 has a bounding box width (W) and a bounding box height (H), and may divided into a number of columns and a number of rows that form the set of cells. As illustrated in FIG. 3, the bounding box 340 has three (3) rows and three (3) columns that form the nine (9) cells. Further, each of the set of cells may have a cell width (Cw) and a cell height (Ch), where the Cw and the Ch may be the same for all of the cells. As a result, Cw is equal to W divided by the number of columns and Ch is equal to H divided by the number of rows.

FIG. 3 further includes a digital content item 341 that is to be positioned in one of the cells of the bounding box 340 or associated section. The digital content item 341 may be any regular or irregular shape (e.g., circle, rectangle, trapezoid, etc.) and may have a content width (x) and a content height (y). In some implementations, a computing device may automatically select which of the cells in which to position the digital content item 341. Alternatively, the computing device may receive, via a user interface, a selection of one of the cells in which to position the digital content item 341. Further, in embodiments, the computing device may automatically resize the digital content item 341 to fit within the selected cell. In an implementation, a user may use the computing device to manually resize the digital content item 341. Any resized digital content item 341 will have the content width (x) and the content height (y).

According to embodiments, the computing device may calculate a position (position.x, position.y) within the bounding box 340 for the digital content item 341 based on certain parameters. Initially, the computing device may identify or determine an (sx,sy) coordinate for the section. According to embodiments, the (sx,sy) coordinate for the section may be the top left corner of the section, and may have a value (0,0), where columns to the right of this corner may represent an increasing x value and rows below this corner may represent an increasing y value. It should be appreciated that any other corner of the section may represent the initial (0,0) coordinate.

The computing device may calculate the value of position.x according to the formula: position.x = sx + (Cw^{∗}column_number) + (Cw/2) - (x/2). Further, the computing device may calculate the value of position.y according to the formula: position.y = sy + (Ch^{∗}row_number) + (Ch/2) - (y/2). In these formulas, the column_number and row_number start at zero (0). Accordingly, as illustrated in FIG. 3, cell 342 is column 2 and row 1, and cell 343 is column 1 and row 2.

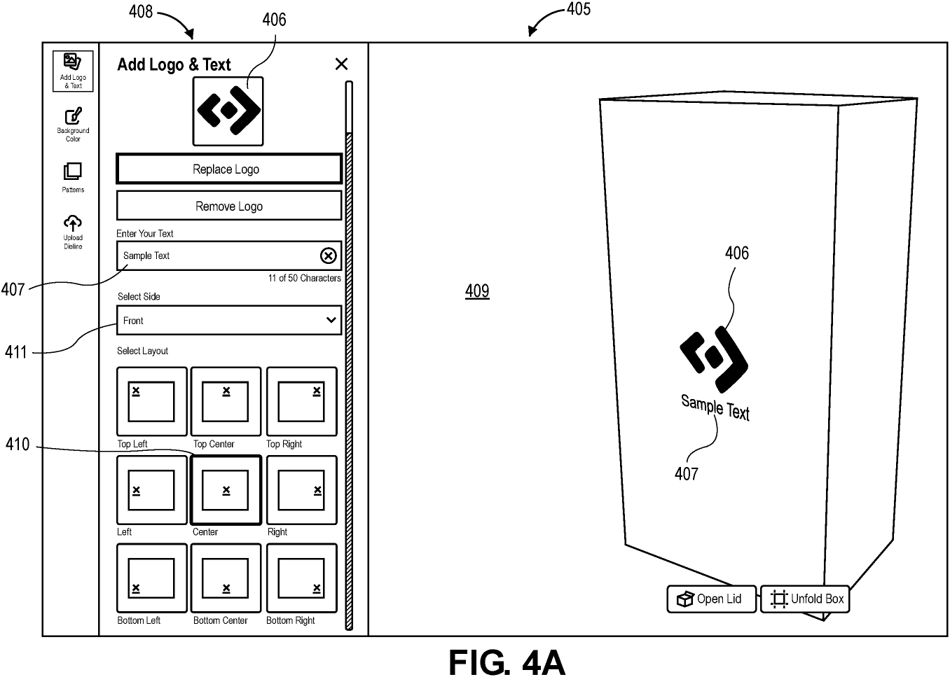

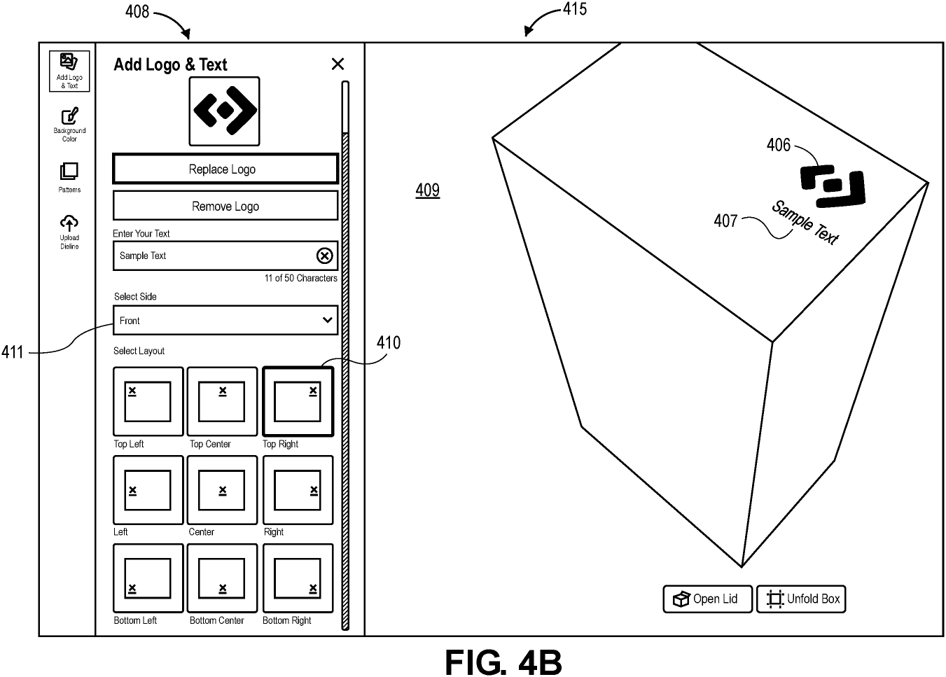

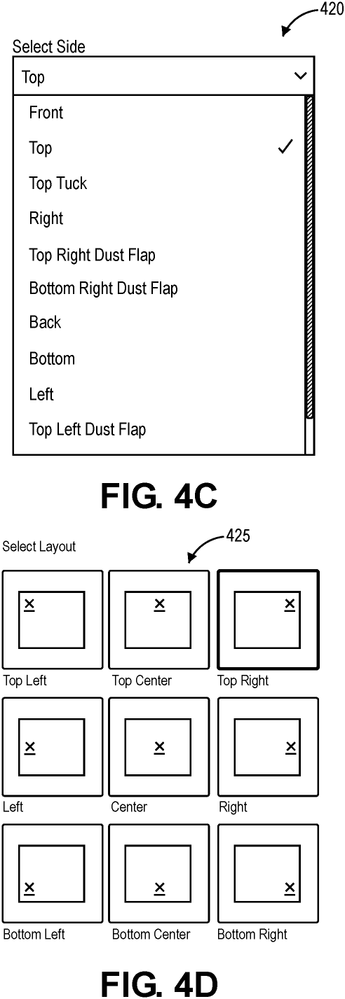

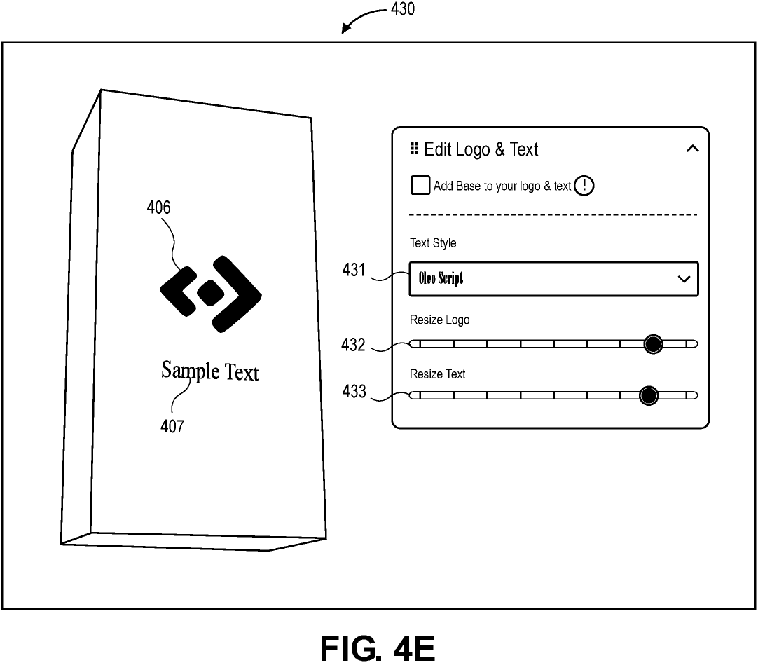

FIGS. 4A-4E illustrate example interfaces associated with a design studio or similar platform for designing a foldable product. It should be appreciated that the interfaces are merely exemplary and that additional or alternative features, content, or the like are envisioned.

FIG. 4A illustrates an interface 405 that may include a selection area 408 and a product display area 409. According to embodiments, the selection area 408 may enable a user to input a set of selections associated with the design of a foldable product and the product display area 409 may display a rendering of the foldable product according to the set of selections made via the selection area 408.

The selection area 408 includes a digital content item 406 (as shown: a logo) that is to be rendered on the foldable product as well as text 407 (as shown: “Sample Text”) that is to be added in association with the digital content item 406. Additionally, the selection area 408 may include a side selection 411 (as shown: Front) from which a user may select which section or surface of the foldable product on which to render the digital content item 405. Moreover, the selection area 408 may include a selected layout 410 (as shown: Center) for the digital content item 406, which may specify where on the selected section of the foldable product the digital content item 406 is to be located or placed. As illustrated in FIG. 4A, the digital content item 406 along with the text 407 is rendered, in the product display area 409, in the center of the front section of the foldable product.

FIG. 4B illustrates an interface 415 that may also include the selection area 408 and the product display area 409. In the interface 415, the side selection 411 indicates a selection of the “Top” of the foldable product and the selected layout 410 indicates a selection of “Top Right”. Accordingly, as illustrated in FIG. 4B, the digital content item 406 along with the text 407 is rendered, in the product display area 409, in the top right of the top section of the foldable product.

FIG. 4C illustrates an interface 420 depicting an exemplary menu of sides or surfaces of an exemplary foldable product. According to embodiments, a user may select a side or surface from the following depicted options: front, top, top tuck, right, top right dust flap, bottom right dust flap, back, bottom, left, and top left dust flap.

FIG. 4D illustrates an interface 425 depicting exemplary layout options for placement of a digital content item on a foldable product. According to embodiments, a user may select a placement from the following depicted options: top left, top center, top right, left, center, right, bottom left, bottom center, and bottom right.

FIG. 4E illustrates an interface 430 that may enable a user to edit or modify digital content items and associated text that is rendered on a foldable product. The interface 430 depicts the foldable product with the digital content item 406 and the text 407 located thereon. Further, the interface 430 may include one or more menus that may enable a user to select to modify the digital content item 406 and/or the text 407. In particular, a text style menu 431 may enable a user to select from various styles for the text 407, a resize logo menu 432 may enable a user to resize the digital content item 406, and a resize text menu 433 may enable a user to resize the text 407.

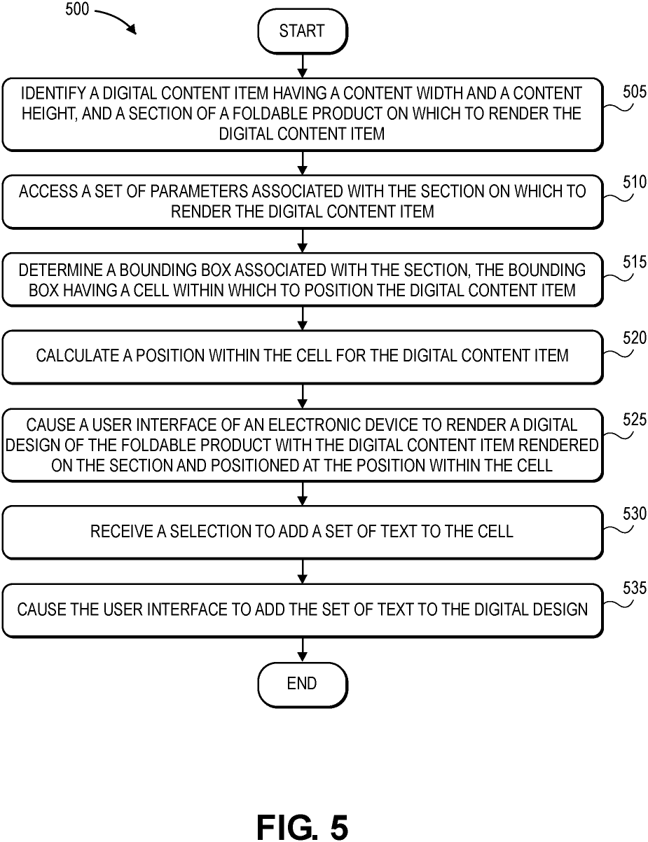

FIG. 5 depicts is a block diagram of an example method 500 of determining content placement on a digital design. The method 500 may be facilitated by an electronic device (such as the central server 110 and/or any of the devices 103, 104, 105 as depicted in FIG. 1A). In embodiments, the electronic device may operate or interface with a virtual design platform, such as via a website, application, or the like. Further, the digital design may be of a foldable product having a plurality of sections.

The method 500 may begin when the electronic device identifies (block 505) a digital content item having a content width and a content height, and a section of the foldable product on which to render the digital content item. In embodiments, the electronic device may receive, via a user interface, a set of selections for the digital content item and the section. It should be appreciated that the set of selections may be default selections or may be selected from a list of templates. Further, it should be appreciated that the digital content item may be resized such that may have various content widths and content heights.

The electronic device may access (block 510) a set of parameters associated with the section on which to render the digital content item. In embodiments, the electronic device may access the set of parameters in the form of a set of scalable vector graphic (SVG) paths associated with the section.

The electronic device may determine (block 515), from the set of parameters, a bounding box associated with the section, where the bounding box may have a cell within which to position the digital content item. In embodiments, the bounding box may have a bounding box width and a bounding box height. Further, the electronic device may receive, via the user interface, a selection of the cell. It should be appreciated that the cell may be a default cell or selected from a list of cells.

The electronic device may calculate (block 520) a position within the cell for the digital content item. In embodiments, the electronic device may calculate the position within the cell based on one or more of: the content width, the content height, the content width, the bounding box width, and/or the bounding box height. Additionally, the cell may be part of a plurality of cells segmented into a set of rows and a set of columns, and the electronic device may calculate the position within the cell further based on a position of the cell within the set of rows and the set of columns. Moreover, the electronic device may calculate the position within the cell further based on a set of coordinates corresponding to a top left corner of the bounding box which, for example, may have (0,0) as its coordinates.

The electronic device may cause (block 525) a user interface of an electronic device to render a digital design of the foldable product with the digital content item rendered on the section and positioned at the position within the cell. In embodiments, the electronic device may render the digital design of the foldable product within an online design studio.

The electronic device may receive (block 530) a selection to add a set of text to the cell. Further, the electronic device may calculate a text position based on at least the position within the cell for the digital content item. The electronic device may cause (block 535) the user interface to add the set of text to the digital design, where the set of text may be positioned at the text position.

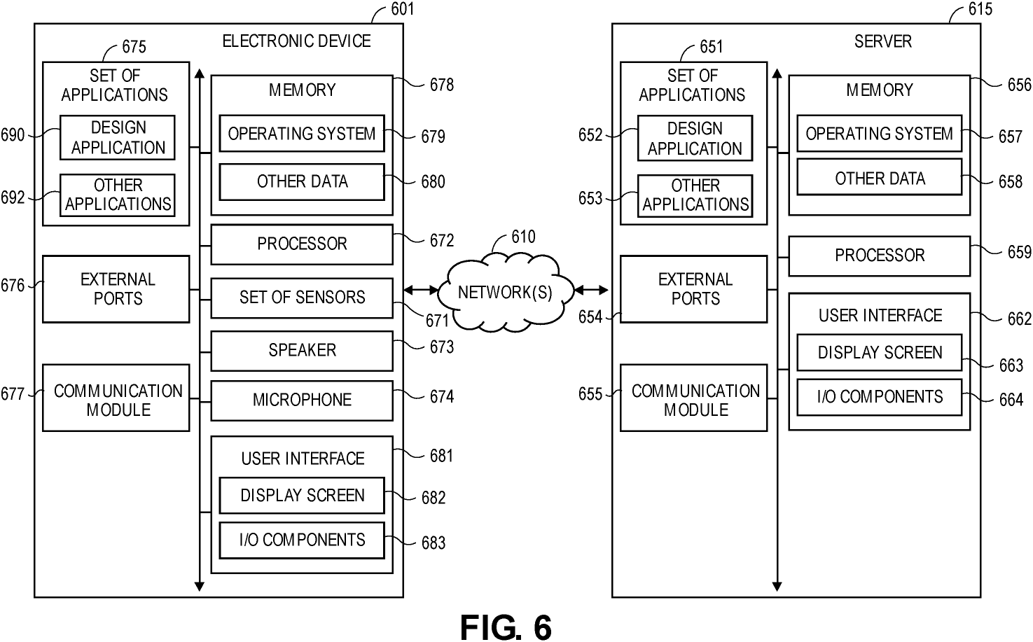

FIG. 6 illustrates a hardware diagram of an example electronic device 601 (e.g., one of the electronic devices 103, 104, 105 as discussed with respect to FIG. 1A) and an example server 615 (e.g., the server 110 as discussed with respect to FIG. 1A), in which the functionalities as discussed herein may be implemented.

The electronic device 601 may include a processor 672 as well as a memory 678. The memory 678 may store an operating system 679 capable of facilitating the functionalities as discussed herein as well as a set of applications 675 (i.e., machine readable instructions). For example, one of the set of applications 675 may be a design application 690, such as a virtual design studio.

The processor 672 may interface with the memory 678 to execute the operating system 679 and the set of applications 675. According to some embodiments, the memory 678 may also store other data 680 that may include digital content items and related design elements. The memory 678 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 601 may further include a communication module 677 configured to communicate data via one or more networks 610. According to some embodiments, the communication module 677 may include one or more transceivers (e.g., WAN, WWAN, WLAN, and/or WPAN transceivers) functioning in accordance with IEEE standards, 3GPP standards, or other standards, and configured to receive and transmit data via one or more external ports 676.

The electronic device 601 may include a set of sensors 671 such as, for example, a location module (e.g., a GPS chip), an image sensor, an accelerometer, a clock, a gyroscope (i.e., an angular rate sensor), a compass, a yaw rate sensor, a tilt sensor, telematics sensors, and/or other sensors. The electronic device 601 may further include a user interface 681 configured to present information to a user and/or receive inputs from the user. As shown in FIG. 6, the user interface 681 may include a display screen 682 and I/O components 683 (e.g., ports, capacitive or resistive touch sensitive input panels, keys, buttons, lights, LEDs, and/or built in or external keyboard). According to some embodiments, the user may access the electronic device 601 via the user interface 681 to input design selections and/or perform other functions. Additionally, the electronic device 601 may include a speaker 673 configured to output audio data and a microphone 674 configured to detect audio.

In some embodiments, the electronic device 601 may perform the functionalities as discussed herein as part of a “cloud” network or may otherwise communicate with other hardware or software components within the cloud to send, retrieve, or otherwise analyze data.

As illustrated in FIG. 6, the electronic device 601 may communicate and interface with the server 615 via the network(s) 610. The server 615 may include a processor 659 as well as a memory 656. The memory 656 may store an operating system 657 capable of facilitating the functionalities as discussed herein as well as a set of applications 651 (i.e., machine readable instructions). For example, one of the set of applications 651 may be a design application 652 such as a virtual design studio. It should be appreciated that one or more other applications 653 are envisioned.

The processor 659 may interface with the memory 656 to execute the operating system 657 and the set of applications 651. According to some embodiments, the memory 656 may also store other data 658 such as data associated with the design application 652. The memory 656 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 615 may further include a communication module 655 configured to communicate data via the one or more networks 610. According to some embodiments, the communication module 655 may include one or more transceivers (e.g., WAN, WWAN, WLAN, and/or WPAN transceivers) functioning in accordance with IEEE standards, 3GPP standards, or other standards, and configured to receive and transmit data via one or more external ports 654.

The server 615 may further include a user interface 662 configured to present information to a user and/or receive inputs from the user. As shown in FIG. 6, the user interface 662 may include a display screen 663 and I/O components 664 (e.g., ports, capacitive or resistive touch sensitive input panels, keys, buttons, lights, LEDs, external or built in keyboard). According to some embodiments, the user may access the server 615 via the user interface 662 to review information, make selections, and/or perform other functions.

In some embodiments, the server 615 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 672, 659 (e.g., working in connection with the respective operating systems 679, 657) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of determining content placement on a digital design of a foldable product having a plurality of sections, the computer-implemented method comprising:
identifying, by one or more processors, (i) a digital content item having a content width and a content height, and (ii) a section of the plurality of sections of the foldable product on which to render the digital content item;
accessing, by the one more processors, a set of parameters associated with the section on which to render the digital content item;
determining, by the one or more processors from the set of parameters, a bounding box associated with the section, the bounding box having a bounding box width and a bounding box height, the bounding box having a cell within which to position the digital content item;
calculating, by the one or more processors, a position within the cell for the digital content item based on at least the content width, the content height, the bounding box width, and the bounding box height; and
causing a user interface of an electronic device to render the digital design of the foldable product with the digital content item rendered on the section and positioned at the position within the cell.

2. The computer-implemented method of claim 1, wherein the cell is part of a plurality of cells segmented into a set of rows and a set of columns, and wherein calculating the position within the cell for the digital content item comprises:
calculating, by the one or more processors, the position within the cell for the digital content item based on at least the content width, the content height, the bounding box width, the bounding box height, and a position of the cell within the set of rows and the set of columns.

3. The computer-implemented method of claim 1, wherein identifying the digital content item and the section comprises:
receiving, via the user interface of the electronic device, a set of selections for the digital content item and the section.

4. The computer-implemented method of claim 1, further comprising:
receiving, via the user interface of the electronic device, a selection of the cell.

5. The computer-implemented method of claim 1, wherein accessing the set of parameters associated with the section comprises:
accessing, by the one or more processors, a set of scalable vector graphic (SVG) paths associated with the section.

6. The computer-implemented method of claim 1, wherein calculating the position within the cell for the digital content item comprises:
calculating, by the one or more processors, the position within the cell for the digital content item further based on a set of coordinates corresponding to a top left corner of the bounding box.

7. The computer-implemented method of claim 1, further comprising:
receiving a selection to add a set of text to the cell;
calculating, by the one or more processors, a text position based on at least the position within the cell for the digital content item; and
causing the user interface of the electronic device to add the set of text at the text position to the digital design of the foldable product that was rendered.

8. The computer-implemented method of claim 1, wherein the one or more processors is part of the electronic device, and wherein causing the user interface of the electronic device to render the digital design of the foldable product comprises:
causing the user interface to render, within an online design studio, the digital design of the foldable product.

9. A system for determining content placement on a digital design of a foldable product having a plurality of sections, comprising:
a user interface;
a memory; and
one or more processors interfacing with the user interface and the memory, and configured to:
identify (i) a digital content item having a content width and a content height, and (ii) a section of the plurality of sections of the foldable product on which to render the digital content item,
access a set of parameters associated with the section on which to render the digital content item,
determine, from the set of parameters, a bounding box associated with the section, the bounding box having a bounding box width and a bounding box height, the bounding box having a cell within which to position the digital content item,
calculate a position within the cell for the digital content item based on at least the content width, the content height, the bounding box width, and the bounding box height, and
cause the user interface to render the digital design of the foldable product with the digital content item rendered on the section and positioned at the position within the cell.

10. The system of claim 9, wherein the cell is part of a plurality of cells segmented into a set of rows and a set of columns, and wherein to calculate the position within the cell for the digital content item, the one or more processors is configured to:
calculate the position within the cell for the digital content item based on at least the content width, the content height, the bounding box width, the bounding box height, and a position of the cell within the set of rows and the set of columns.

11. The system of claim 9, wherein to identify the digital content item and the section, the one or more processors is configured to:
receive, via the user interface, a set of selections for the digital content item and the section.

12. The system of claim 9, wherein the one or more processors is further configured to: receive, via the user interface, a selection of the cell.

13. The system of claim 9, wherein the set of parameters associated with the section is a set of scalable vector graphic (SVG) paths associated with the section.

14. The system of claim 9, wherein to calculate the position within the cell for the digital content item, the processor is configured to:
calculate the position within the cell for the digital content item further based on a set of coordinates corresponding to a top left corner of the bounding box.

15. The system of claim 9, wherein the one or more processors is further configured to: receive a selection to add a set of text to the cell,
calculate a text position based on at least the position within the cell for the digital content item, and
cause the user interface to add the set of text at the text position to the digital design of the foldable product that was rendered.

16. The system of claim 9, wherein the one or more processors causes the user interface to render, within an online design studio, the digital design of the foldable product.

17. A computer-implemented method of rendering a digital design of a foldable product having a plurality of sections, the computer-implemented method comprising:
receiving, by one or more processors via a user interface, a set of selections for (i) a digital content item having a content width and a content height, (ii) a section of the plurality of sections of the foldable product on which to render the digital content item, and (iii) a layout associated with the section at which to position the digital content item;
determining, by the one or more processors, a bounding box associated with the section, the bounding box having a bounding box width and a bounding box height, and, based on the layout, a cell of the bounding box within which to position the digital content item;
calculating, by the one or more processors, a position within the cell for the digital content item based on at least the content width, the content height, the bounding box width, and the bounding box height; and
displaying, in the user interface, the digital design of the foldable product with the digital content item rendered on the section and positioned at the position within the cell.

18. The computer-implemented method of claim 17, further comprising:
receiving a selection to add a set of text to the cell;
calculating, by the one or more processors, a text position based on at least the position within the cell for the digital content item; and
displaying, in the user interface, the set of text added to the digital design at the text position.

19. The computer-implemented method of claim 17, wherein the cell is part of a plurality of cells segmented into a set of rows and a set of columns, and wherein calculating the position within the cell for the digital content item comprises:
calculating, by the one or more processors, the position within the cell for the digital content item based on at least the content width, the content height, the bounding box width, the bounding box height, and a position of the cell within the set of rows and the set of columns.

20. The computer-implemented method of claim 17, wherein displaying the digital design comprises:
displaying, in the user interface as part of an online design studio, the digital design of the foldable product with the digital content item rendered on the section and positioned at the position within the cell.
